(19) United States
(12) Patent Application Publication
(10) Pub. No.: US 2026/0257699 A1
(43) Pub. Date: Sep. 3, 2026

(54) Method for Operating a Motor Vehicle, Controller, and Motor Vehicle

(71) Applicant: Robert Bosch GmbH, Stuttgart (DE)

(72) Inventor: Michael Friedel, Ruppertshofen (DE)

(21) Appl. No.: 19/163,069

(22) PCT Filed: Mar. 8, 2023
(86) PCT No.: PCT/EP2024/056214

§ 371 Date: Sep. 8, 2025

(30) Foreign Application Priority Data
Mar. 10, 2023 (DE) 10 2023 202 150.1

(51) Int. Cl. B60W 60/00; B60W 50/00; B60W 50/02; B60W 50/029

(52) U.S. Cl. CPC B60W 60/007; B60W 50/0205; B60W 50/0225; B60W 50/029; B60W 60/0051; B60W 2050/0026; B60W 2050/021; B60W 2050/022; B60W 2050/0297; B60W 2520/10; B60W 2552/20; B60W 2552/35

(57) ABSTRACT

A method for operating a motor vehicle is disclosed. The motor vehicle includes at least one actuation device which can be actuated by a driver for specifying a braking, accelerating and/or steering request. At least a first sensor for detecting an actuation of the actuation device is associated with the actuation device. The actuation device and/or the first sensor are monitored for a malfunction. If a malfunction of the actuation device and/or the first sensor has been detected, an at least semi-autonomous driving operation of the motor vehicle is activated after a specified time delay, and at least one autonomous driving maneuver is carried out.

The invention relates to a method for operating a motor vehicle, wherein the motor vehicle comprises at least one actuation device which can be actuated by a driver for specifying a braking, acceleration and/or steering request, wherein the actuation device is associated with at least one first sensor for detecting an actuation of the actuation device, and wherein the actuation device and/or the first sensor are monitored for a malfunction.

The invention also relates to a control device for a motor vehicle and a motor vehicle.

### PRIOR ART

From the prior art, it is known to detect an actuation of an actuation device for a motor vehicle which can be actuated by a driver using a sensor associated with the actuation device. If the driver actuates the actuation device, a braking or acceleration request of the driver is in particular detected as a function thereof. For example, brake systems with electromechanical brake amplifiers are known that, together with a vehicle assistance system, in particular an electronic stability program (ESP), form a redundant brake-by-wire system, in which there is no mechanical connection from the actuation device to the brake system. A braking request is forwarded, for example, as a function of an actuation of the actuation device to an electromechanical actuator which is designed to carry out a pressure build-up in the braking system.

Methods for detecting malfunctions of the actuation device and/or the sensor are known as well. The patent application DE 10 2018 113 865A1, for example, discloses a method for determining the state of a pedal actuation system in a vehicle, wherein a normal operating state or an error state of an actuating pedal is identified as a function of two sensor signals.

### DISCLOSURE OF THE INVENTION

The method according to the invention having the features of Claim 1 is characterized in that, if a malfunction of the actuation device and/or the first sensor has been detected, an at least semi-autonomous driving operation of the motor vehicle is activated after a specified time delay, and at least one autonomous driving maneuver is carried out. The activation of the at least semi-autonomous driving operation ensures safe continued operation of the motor vehicle if it is no longer possible to clearly determine and implement an actuation of the actuation device due to a faulty actuation device and/or a faulty sensor. An autonomous driving operation is in particular activated automatically, i.e. without the driver being able to intervene. The time delay prior to activation creates a period of time during which the malfunction is still correctable and recognized as corrected. In particular, a delay value of the delay is a maximum of 100 ms. Preferably, if the malfunction is not corrected, an emergency trajectory is set, for example, a controlled stop of the motor vehicle, in which the motor vehicle is brought to a stop and held as a safe state as quickly as possible. Alternatively, if the malfunction is not corrected, the driving operation is permanently activated, in particular to achieve a predetermined destination, and a transfer of control to the driver is prevented. No such emergency trajectory must then be set, but the motor vehicle is continued in the normal, at least semi-autonomous driving operation at least for the time being, in particular at least until the destination is reached. There is in particular no provision to transfer of control of the motor vehicle to the driver, at least as long as the malfunction is not detected as being corrected. In the event of such a malfunction, the motor vehicle can advantageously only be operated safely during autonomous driving operation. Advantageously, a driving operation according to SAE level 3 (automated), level 4 (highly automated) or level 5 (fully automated) is activated, and that the driving operation can only be deactivated again or is deactivated when the malfunction is identified as having been corrected, and/or that control over the faulty and/or another actuation device is taken away from the driver. Deactivating or allowing deactivation only if the malfunction has been corrected advantageously ensures safe continued operation of the motor vehicle. Taking control of the actuation device away advantageously ensures that the driver cannot intervene in the control of the motor vehicle in a way that interferes with the autonomous driving mode and thus potentially jeopardizes the safe continued operation of the motor vehicle. When a malfunction is detected, a message is particularly preferably output to the driver, for example on a display device assigned to the driver. The message in particular includes information about the activation of the at least partially autonomous driving operation and/or an instruction to the driver to check and address the malfunction, for example a request to take the vehicle to a workshop.

According to a preferred further development of the invention, if the malfunction is found to be corrected during the delay, the method is ended without activating the driving operation. This advantageously ensures that the method is only carried out according to needs if the malfunction still exists even after waiting for the delay. In particular, self-healing is awaited within the delay, i.e., that a missing sensor signal is received again, for example, because there was a temporary error in the bus communication.

Particularly preferably, it is provided that a specified number of electrical reset attempts (reset) are carried out on a control device associated with the actuation device and/or the sensor in order to correct the malfunction. The advantage of such a reset is that an active attempt is made to correct the malfunction, so that, if the reset is successful, the method can be ended without having to switch to at least semi-autonomous driving operation. In particular, even after activating the driving operation, further attempts are made to correct the malfunction, for example by periodically performing resets. Once such a reset has been successful, the method is then preferably ended with the transfer of control of the motor vehicle to a driver. For example, at least one reset attempt is provided, preferably as long as an actual speed of the motor vehicle is below a specified speed threshold.

According to a preferred further development of the invention, it is provided that the actuation device is assigned at least one second sensor for redundantly detecting the actuation, and that sensor signals from the sensors are monitored for a malfunction, in particular by comparing them with one another. The redundant detection of the actuation of the actuation device has the advantage that reliable identification of a respective input of the driver is ensured at all times, even if one of the sensors fails. The actuation of the actuation device is preferably detected by means of one or two sensors disposed on the actuation device, for example angle sensors, displacement sensors, pressure sensors or force sensors, and the at least semi-autonomous driving operation is in particular activated only when these sensors fail. Control therefore advantageously has to only be taken away from the driver if all of the sensors have failed or are defective.

It is particularly preferably provided that a steering device, a brake system and/or a drive unit of the motor vehicle are controlled as a function of an actuation of the actuation device. Such a configuration of the actuation device advantageously ensures that a steering request, acceleration request and/or delay request of a driver of the motor vehicle is reliably detected. The actuation device is preferably part of a steer-by-wire system, a brake-by-wire system and/or a drive-by-wire system; i.e. it has no mechanical connection to the steering device, brake system and/or drive unit. The actuation is in particular detected as a function of a displacement path and/or a spatial position of the actuation device.

The actuation device is in particular configured as an actuating surface, pedal, joystick or steering handle. The actuating surface is preferably configured to output acceleration and/or delay requests to the brake system and/or the drive unit. In particular an actuation force of the actuating surface is ascertained for this purpose. The actuating surface is preferably at least largely stationary or without travel, i.e. not or at least only slightly displaceable. The pedal is preferably an accelerator pedal, a brake pedal or a combined accelerator pedal that is configured to output acceleration and delay requests to both the brake system and/or the drive unit. With such an output and control, the advantages of the method according to the invention are particularly pronounced. The joystick is particularly preferably configured to output both acceleration requests and delay requests, and in particular alternatively or additionally steering requests. In particular a displacement path, an angle of movement and/or a speed of actuation of the joystick or pedal are acquired for this purpose. An acceleration request or a delay request is preferably detected in particular as a function of a direction of movement of the joystick, and either the drive unit or the brake system is controlled accordingly. A vehicle delay request is set by a driver via the joystick, for instance. A signal is transmitted to a component of a brake system of the motor vehicle, for example a controllable actuator, according to its movement, in particular its movement speed or its angle of movement, and a corresponding brake pressure is built up by the actuator as described above.

According to a preferred further development of the invention, it is provided that an actual speed of the motor vehicle is recorded and that a delay value for the time delay and/or a number of reset attempts, in particular in stages, is specified as a function of the actual speed. By taking the actual speed into account, it is advantageously ensured that a risk assessment resulting from the actual speed is considered.

In particular, the delay value is a maximum of 100 ms. For example, a time period of 100 ms is provided as a delay value and/or at least 2 reset attempts for a speed up to a first specified threshold, for example up to 15 km/h, a time period of 50 ms as a delay value and/or at least 1 reset attempt up to a second specified threshold, for example up to 50 km/h, and a time period of 15 ms as a delay value for a speed from the second specified threshold, for example from 50 km/h, for example, wherein no further reset attempt is carried out if the second threshold is exceeded.

Particularly preferably, it is provided that a delay value and/or a number of reset attempts are each defined for at least two, in particular for a plurality of speed ranges, and that the delay value and/or the number of reset attempts within whose speed range the actual speed lies is specified. Corresponding speed ranges provide a particularly advantageous and simple option for assigning and specifying different delay values and/or reset attempts.

According to a preferred further development of the invention, it is contemplated that the delay value and/or the number of reset attempts decrease, in particular linearly or exponentially, with the actual speed. This advantageously ensures that the higher the actual speed of the motor vehicle, the faster the activation of the at least semi-autonomous driving operation occurs. This means that there is less waiting time before the driving operation is activated. In this respect, the actual speed represents an advantageous hazard indicator for the occupants of the motor vehicle and their environment.

Particularly preferably, it is contemplated that the actual speed is assigned to a delay value and/or a number of reset attempts by a characteristic curve or a look-up table. This results in the advantage that a corresponding delay value and/or a number of reverse attempts are consistently assigned for each speed value.

According to a preferred further development of the invention, it is provided that information relating to a location and/or environment of the motor vehicle is detected, information, and that a delay value for the time delay and/or a number of reset attempts is specified as a function of the information. By taking the information into account in this way, it is advantageously ensured that the delay value and/or the number of reset attempts are always adapted to the driving situation resulting from the information. For example, sensor data of a vehicle assistance system of the vehicle is evaluated, in particular image data of a camera capturing the vehicle environment.

Particularly preferably, it is contemplated that the information is assigned to a delay value and/or a number of reset attempts by a characteristic curve or a look-up table. This results in the advantage that a corresponding delay value and/or a number of reverse attempts are consistently assigned for each value of the information.

According to a preferred further development of the invention, it is provided that the information comprises a surface condition of a roadway on which the motor vehicle is traveling. By taking such a surface condition into account, it is advantageously ensured that a current or expected driving behavior of the motor vehicle is taken into account when determining the delay value and/or the number of reset attempts. Particularly preferably, the condition of a road on which the motor vehicle is traveling and/or weather conditions in the vicinity of the motor vehicle are evaluated. For example, the surface condition or the surface of the roadway subsurface includes a road condition, such as a frictional value of the roadway, particularly affected by gravel, snow, sand, and/or heavy rain. Particularly preferred, for example in the event of a malfunction of a steering handle, are lower deceleration values and/or fewer reset attempts in unfavorable road conditions and/or weather conditions, especially in snow and ice, than in favorable road conditions or weather conditions, for example on a dry road.

Particularly preferably, the information is provided to include a curve profile of a roadway on which the vehicle is traveling. The advantage of taking the curve profile into account is that an actual or expected trajectory of the vehicle is taken into account when determining the delay value and/or the number of reset attempts. If, for example, a malfunction of a steering handle is detected, lower delay values and/or fewer reset attempts are specified for a route characterized by tight curve profiles than when driving straight ahead.

The control unit for a motor vehicle according to the invention having the features of claim 14 is characterized in that the control unit is specifically configured so as to perform the method according to the invention. The advantages specified hereinabove are achieved as a result.

The motor vehicle according to the invention having the features of Claim 15 comprises at least one actuation device which can be actuated by a driver and at least one first sensor and is characterized by the control device according to the invention. This also results in the advantages specified hereinabove.

Further preferred features and combinations of features result from the previous description and from the claims. The invention is explained in more detail below with reference to the drawings. Shown are:

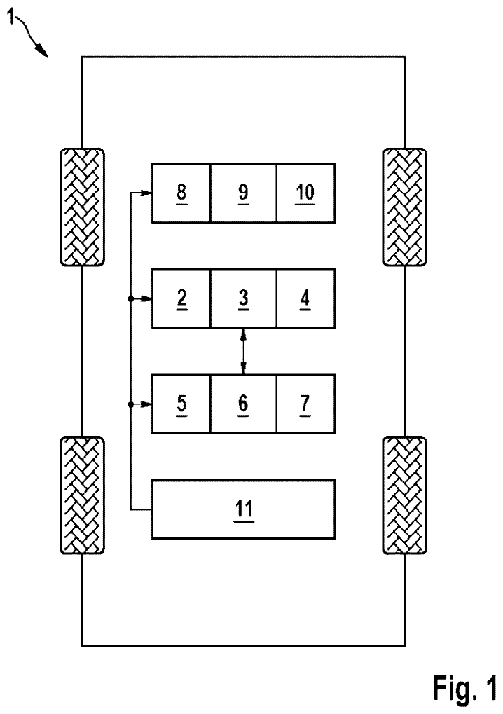

FIG. 1 a motor vehicle, and

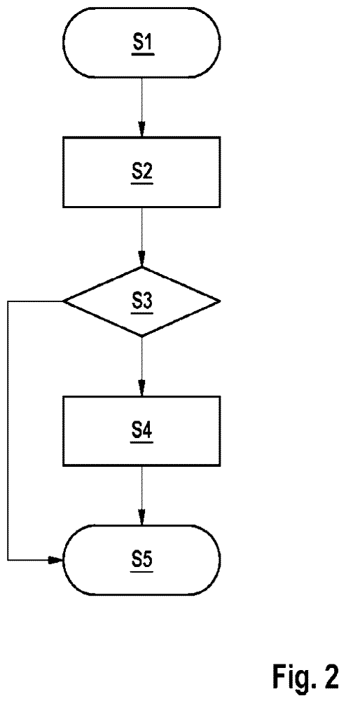

FIG. 2 a method for operating the motor vehicle.

FIG. 1 shows a motor vehicle 1; in this case comprising a first actuation device 2, for example configured as a brake pedal, a second actuation device 3, for example configured as an accelerator pedal, and a third actuation device 4, for example configured as a steering handle. The actuation devices 2, 3, 4 are all configured to be actuated by a driver of the motor vehicle 1.

For this purpose, each of the actuation devices 2, 3, 4 here is assigned a first sensor 5, a second sensor 6 and a third sensor 7 for redundantly detecting actuation of the actuation device 2, 3, 4 as indicated by respective double arrows. For the sake of clarity, only one of the sensors 5, 6, 7 is shown in each case in FIG. 1. A brake system 8, a drive unit 9 and a steering device 10 of the motor vehicle 1 are controlled as a function of a detected actuation of the actuation device 2, 3,4.

The motor vehicle 1 further comprises at least one control device, in particular a plurality of control devices 11. The control device 11 is in particular configured to monitor the sensors 5, 6, 7 for a malfunction, and to control the brake system 8, the drive unit 9 and the steering device 10 as a function of actuation of the actuation device 2, 3, 4 as indicated by arrows.

The following describes an advantageous method for operating the motor vehicle 1, with reference to FIG. 2. For this purpose, FIG. 2 shows the method in the form of a flow chart. The method in particular ensures that safe continued operation of the motor vehicle 1 is advantageously ensured if it is no longer possible to clearly determine and implement an actuation of the actuation devices 2, 3, 4 due to a faulty actuation device 2, 3, 4 and/or a plurality of faulty sensors 5, 6, 7. In addition, a time period is advantageously created in which the malfunction is still correctable and can be recognized as corrected.

In a step S1, the method begins by monitoring the actuation devices 2, 3, 4 and the sensors 5, 6, 7 for a malfunction. If a malfunction is identified, the method is continued with a step S2.

In step S2, a delay value for a time delay is specified, after which an at least semi-autonomous driving operation of the motor vehicle 1 is activated and at least one autonomous driving maneuver is to be carried out if the malfunction still exists. Particularly preferred is a number of electrical reset attempts of control device 11 associated with the actuation device 2, 3, 4 and/or sensors 5, 6, 7 are provided to correct the malfunction.

Preferably, an actual speed of the motor vehicle 1 is detected and the delay value and/or the number of reset attempts, in particular in stages, is specified as a function of the actual speed. For example, a delay value is set for at least two, in particular for a plurality of speed ranges, and the delay value within whose speed range the actual speed lies is specified. Preferably, the delay value and/or the number of reset attempts decreases, in particular linearly or exponentially, with the actual speed. In particular the actual speed is assigned to a delay value and/or a number of reset attempts by a characteristic curve or a look-up table.

Alternatively or in addition to the actual speed, information relating to a location and/or an environment of the motor vehicle is detected, and the delay value and/or the number of reset attempts are predetermined as a function of the information. In particular the information is assigned to a delay value and/or a number of reset attempts by a characteristic curve or a look-up table. The information preferably comprises a surface finish and/or a curve of a roadway on which the motor vehicle is traveling.

In a subsequent step S3, it is checked whether the malfunction continues to exist during the delay value specified in step S2. Either a passive wait is performed and/or, preferably the number of reset attempts, also provided in step S2, in order to actively correct the malfunction.

If the malfunction is found to be corrected during the delay, the method is ended without activating the driving operation with a step S5. The motor vehicle then continues to operate in a normal operation.

If the malfunction remains after the delay has elapsed, however, the method is continued with a step S4.

In step S4, an at least semi-autonomous driving operation of the motor vehicle 1 is activated and at least one autonomous driving maneuver is carried out, in particular to reach a specified destination. The method is continued with step S5, for example when the specified destination is reached.

In the meantime, it is in particular further checked whether the malfunction is corrected. Further reset attempts are carried out periodically, for example. As soon as it is detected that the malfunction has been corrected, autonomous driving operation mode can be deactivated, for example in response to a request from the driver. The system now either waits until the driver requests deactivation of the autonomous driving mode or the autonomous driving mode is automatically deactivated and the method is continued with step S5.

The method then ends with the step S5, in which the autonomous driving mode is deactivated and control of the motor vehicle 1 is fully returned to the driver.

1. A method for operating a motor vehicle having at least one actuation device, the method comprising:
actuating the at least one actuation device by a driver so as to specify a braking, accelerating and/or steering request;
detecting an actuation of the actuation device with at least a first sensor that is associated with the actuation device;
monitoring the actuation device and/or the first sensor for a malfunction; and
if a malfunction of the actuation device and/or the first sensor has been detected, activating an at least semi-autonomous driving operation of the motor vehicle after a specified time delay, and carrying out at least one autonomous driving maneuver.

2. The method according to claim 1, wherein if the malfunction is detected to be corrected during the delay, the method is ended without activating the driving operation.

3. The method according to claim 2, wherein a specified number of electrical reset attempts are carried out for a control device associated with the actuation device and/or the sensor in order to correct the malfunction.

4. The method according to claim 1, wherein the actuation device is associated with at least one second sensor for redundantly detecting the actuation, and wherein sensor signals from the sensors are monitored for a malfunction by comparing them with one another.

5. The method according to claim 1, wherein a steering device, a brake system and/or a drive unit of the motor vehicle are controlled as a function of an actuation of the actuation device.

6. The method according to claim 1, wherein an actual speed of the motor vehicle is detected, and wherein a delay value for the time delay and/or a number of reset attempts, in stages, is specified as a function of the actual speed.

7. The method according to claim 6, wherein for a plurality of speed ranges, a delay value and/or a number of reset attempts are each set, and wherein the delay value and/or the number of reset attempts within whose speed range the actual speed lies is specified.

8. The method according to claim 6, wherein the delay value and/or the number of reset attempts decreases, linearly or exponentially, with the actual speed.

9. The method according to claim 6, wherein the actual speed is associated with a delay value and/or a number of reset attempts by a characteristic curve or a look-up table.

10. The method according to claim 1, wherein information relating to a location and/or an environment of the motor vehicle is detected, and wherein a delay value for the time delay and/or a number of reset attempts is specified as a function of the information.

11. The method according to claim 10, wherein the information is associated with a delay value and/or a number of reset attempts by a characteristic curve or a look-up table.

12. The method according to claim 10, wherein the information comprises a surface condition of a roadway on which the motor vehicle travels.

13. The method according to claim 10, wherein the information comprises a curve profile of a roadway on which the motor vehicle travels.

14. A control unit for a motor vehicle, wherein the control unit is configured so as to perform the method according to claim 1.

15. A motor vehicle, comprising:
at least one actuation device configured to be actuated by a driver; and
at least one first sensor that includes the control unit according to claim 14.
